(19) United States
(12) Patent Application Publication
(10) Pub. No.: US 2004/0103157 A1
(43) Pub. Date: May 27, 2004

(54) Store-and-forward server and method for storing and forwarding for instant messaging service implemented in IP multimedia core network subsystem (IMS)

(75) Inventors: Jose Costa Requena, Helsinki (FI); Inmaculada Espigares, Helsinki (FI); Jose Fernandez-Fuentes, Barcelona (ES); Timo Haataja, Kauniainen (FI); Juha Kalliokulju, Vesilahti (FI); Heikki Einola, Espoo (FI); Tapio Holopainen, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/387,807

(22) Filed: Mar. 12, 2003

Related U.S. Application Data
(60) Provisional application No. 60/373,760, filed on Apr. 17, 2002.

(51) Int. Cl. G06F 15/16

(52) U.S. Cl. 709/206; 709/227

(57) ABSTRACT

A new functionality is defined for addition to a known multimedia messaging service to enable interfacing with the mobile multimedia architecture as provided by the IP multimedia core network subsystem (IMS) of the Third Generation Partnership Project (3GPP).

### BACKGROUND OF THE INVENTION

1. Technical Field

The present invention relates to multimedia messaging and, more particularly, as implemented on mobile networks.

2. Discussion of Related Art

It has been known to utilize a proprietary Multimedia Messaging Service (MMS) as a natural continuation of the previously known Short Message Service (SMS) and Picture Messaging. Like SMS centers, MMS centers (MMSCs) also provide reliable, scalable store and forward platforms. For instance, such a known proprietary MMS center runs on second generation (2G), General Packet Radio System (GPRS) and third generation (3G) networks utilizing Wireless Access Protocol (WAP) to deliver messages. Such a known MMSC has been designed as an open platform based on Third Generation Partnership Project (3GPP) and WAP specifications.

Through the MMS center, text, photo images, voice and video clips can be sent from one mobile device to another. The MMS center also supports communication between mobile devices and Internet applications. Messages are sent to either a Mobile Station ISDN address or an email address. To benefit end-users, mobile number portability (MNP) is supported.

As with SMS, end-users are provided with the possibility to request a delivery report on the status of a message as well as to set a message's maximum lifetime. MMS messages can be sent to multiple recipients. The receiver is notified of the incoming message with an MMS notification using SMS as a bearer. Whether this notification is visible to the receiver or not, is a matter of phone implementation.

Subsequent to the development of the MMS, there has been an open architecture Internet Protocol (IP) approach under development. It is called the IP Multimedia Core Network Subsystem (IMS) and includes network elements as defined in 3GPP TS 23.002 v5.6.0 (2002-03) Third Generation Partnership Project; Technical Specification, Group Services and Systems Aspects; Network Architecture (Release 5), particularly as shown in FIG. 6 thereof as described in Section 5.5 Configuration of IM Subsystem Entities and as further detailed in Section 4a.7 entitled IP Multimedia (IM) Core Network (CN) Subsystem Entities. There, a Call Session Control Function (CSCF) is shown interfacing with a home subscriber server (HSS) which acts as a master database for a given user and also containing subscription-related information to support the network entities actually handling calls/sessions. A CSCF also interfaces with a media gateway control function (MGCF) that controls the parts of the call state that pertain to connection control for media channels in an IM-MGW (IP multimedia-media gateway function). An IM-MGW will terminate bearer channels from a switched circuit network and media streams from a packet network (e.g. Real time Transport Protocol (RTP) streams in an IP network).

Considering the fact that the prior MMS centers do not utilize the known session initiation protocol (SIP) which is an important feature of the developing IMS system mentioned above, it would be advantageous to define a new functionality that can be added to the known MMSC. This functionality would enable the MMSC to be able to handle and interface with the mobile multimedia architecture as provided by the EMS or similar SIP based network particularly for handling instant messaging and presence services.

A problem with making such an interface is that in SIP networks such as the IMS network mentioned above, when the SIP MESSAGE method is used in a stand alone manner, i.e., out of a session, it is considered by default by the IMS or SIP-based network as being Instant Messaging. Thus, if a SIP MESSAGE method were to arrive at an MMSC, the default Multimedia Message (MM) handshake mechanism would be applied and the Instant Messaging feature would be lost. It would be desirable to be able to keep the Instant Messaging feature assigned by default to the SIP MESSAGE in the IMS or SIP based networks.

### DISCLOSURE OF INVENTION

An object of the present invention is to define a new functionality that enables an interface with the mobile multimedia architecture as provided by the IMS or other SIP based network.

According to a first aspect of the present invention, a method comprises the steps of receiving a message including a signaling flag indicative of whether to establish an instant messaging session for instant messages from and to a client user equipment (UE) or to simply forward a message from the UE, and storing and forwarding an instant message from the UE after establishing the instant messaging session, or simply forwarding the message including the signaling flag from the UE depending on the signaling flag.

According to a second aspect of the present invention, an apparatus comprises means for receiving a message including a signaling flag indicative of whether to establish an instant messaging session for instant messages from and to a client user equipment (UE) or to simply forward a message from the UE, and means for storing and forwarding an instant message from the UE after establishing the instant messaging session, or simply forwarding the message including the signaling flag from the UE depending on the signaling flag.

In further accord with the first and second aspects of the present invention, the message includes a message body having a field and value together indicative of characteristics of the instant messaging session. The message can be a SIP INVITE and the field be indicated in the Session Description Protocol (SDP) protocol by a single letter m followed by an equal sign followed by the value. The message can be a SIP message including a content-disposition entity or similar header indicative of whether to store and forward the SIP message or to simply forward said SIP message without storage or using SIP message reception and delivery notification. The content-disposition or similar header may for instance have the format: Content-Disposition: instant or Content-Disposition: store&fwd.

The actual specifications in the existing MMSC use specific MMS messages for receiving and sending Multimedia Messages between terminals. Therefore, to extend and ensure the lifetime of the MMSC in the IMS system or other SIP based systems, it will require an interface towards the application server and/or the Serving-CSCF or any SIP server with similar functionality. In using such an interface, the MMSC will receive orders for establishing a messaging session between IMS terminals. In IMS the session is established using SIP methods. The messaging session can be of the Instant Messaging type where there is no session established and the messages are exchanged using the SIP MESSAGE method or the Internet Message Transfer Protocol (IMTP). In case the user wants to establish a messaging (chat) session the information is passed from the Application Server, the S-CSCF or a SIP server to the MMSC. Therefore, this element will be included into the MMSC to enable these capabilities into the existing MMS servers.

The invention defines the functionality that the MMSC needs to include to be able to perform the same messaging services as in the IMS system. The idea is to include a service relay that receives messages from IMS or other SIP systems and maps them into equivalent MMS transactions. The relay should handle all the IMS messages to perform the messaging services in IMS. This functionality permits use of an MMSC in an IMS system. The MMS-IMS relay will require an interface between the application server or the Serving-CSCF (S-Call Session Control Function), or a SIP proxy server with similar functions to the S-CSCF and a message translator. The interface is used to receive the orders for establishing a messaging session or for exchanging the delivery reports and to send notifications about received MM to IMS terminals or other SIP devices. The Application Server (AS) or S-CSCF will send the addresses of the participants and their terminal capabilities. Afterwards, the MMSC should be able to receive and send SIP methods (MESSAGE) or IMTP messages (Internet Message Transfer Protocol is another transport protocol proposed for messaging in IETF and probably will be adopted in the 3GPP IMS, or it will be a similar congestion safe transport protocol used for messaging sessions). Therefore, the MMS-IMS relay includes two new features. Firstly, it includes the interface between an MMSC and an AS and/or a Serving-CSCF or similar SIP server. This interface is used for exchanging orders for establishing a messaging session among multiple users. The interface is also used for receiving control messages and delivery of received MM notifications from the MMSC to the AS or to the S-CSCF. For the case where the user sends single messages (using the SIP MESSAGE method) through the AS or S-CSCF and it is delivered via the MMSC, the MMSC will send back the delivery report to the AS or S-CSCF and from there it will be forwarded as normal SIP NOTIFY method or SIP MESSAGE method with specific content type. Therefore, this relay enables the use of an MMSC for messaging delivery using its default transport and then convert back to SIP the delivery reports. The relay also permits to send the MESSAGE or IMTP messages directly from the terminal to the MMSC. The MMSC then will forward the messages to the rest of participants, which information is received via the new interface from the Application Server or the S-CSCF. The relay also permits to send the MESSAGE or similar SIP message (NOTIFY) to IMS terminals as a notification when a MM is received.

This invention defines a new set of SDP media types to indicate what kind of messaging session the user wants to establish via the MMSC. The invention also defines a set of extensions to be included in the SIP MESSAGE to inform either the Application Server or the MMSC directly about the type of messaging session (Instant or Store and Forward). This invention defines also the usage of SIP MESSAGE for MM reception notification as an evolution of the SMS bearer.

According further to the foregoing and as further detailed below, it will be understood that the invention defines the functionality that will allow the MMS Center (MMSC) to perform an instant messaging service. It defines new parameters to be included into the SDP part of a session initiation protocol (SIP) message when the user wants to establish an instant messaging session among multiple users. The messaging session is established via the Serving-CSCF (Serving Call Session Control Function) and/or the Application Server (AS) or any SIP server with similar functionality (SIP Proxy server). To do this, a control interface is defined between one of these network elements and the MMSC. Thus, the MMSC will receive the orders from the AS with the terminal information of all the participants. The control includes also the information for storage of the messages and whether the user that establishes the session wants to keep a message history. In that case, the messages will be stored for a while in the MMSC and the MMSC relay implements the required functionality to inform the user about history reports (using SIP SUBSCRIBE/NOTIFY with specific Event headers or other SIP messages with similar functionality). In case the messaging session is purely “Instant” the control should indicate to the MMSC that the messages have to be delivered immediately, even if the default MMS handshake with the terminal indicates to “Defer” the message. The “Defer” is a message part of the handshake between terminal and MMSC. It is sent from the terminal to the MMSC for indicating that terminal cannot handle the message and prefers to fetch it later. Therefore, this mechanism provides the Store and Forward mechanism in MMSC and, if applied, the messaging cannot be considered instant. It will be an implementation issue whether the MMSC manufacturer still wants to keep that feature for Instant Messaging. As mentioned above, in SIP networks (IMS) when the SIP MESSAGE method is used as standalone out of a session, it is considered by default as Instant Messaging. Thus when the SIP MESSAGE method arrives to the MMSC the default MM handshake mechanism is applied and the Instant Messaging feature is lost, so it is necessary to explicitly indicate that the MESSAGE should be delivered instantly. In case there is no session establishment, the message (SIP method MESSAGE) will be sent through the AS or directly to the MMSC. In this case, if the user wants to perform the same mechanism, either the store-and-forward feature (default according to MMS specifications) or “Instant” messaging, the control information would be embedded into the SIP MESSAGE. This invention shows how to use the “Content-Disposition” or alternative SIP header with similar functionality extended with new values for example named “instant” and “store&fwd”. Whether this is the parameter to be used and the header to include that parameter will depend on IETF standardization. Nevertheless, as an example this could be a logical way of implementing this feature. Thus when the MMS center will receive the MESSAGE with the appropriate value in the “Content-Disposition” header it will perform either a store-and-forward procedure or will send the message without storing in order to keep the Instant messaging feature assigned to SIP MESSAGE in IMS or SIP based networks.

These and other objects, features and advantages of the present invention will become more apparent in light of the following detailed description of a best mode embodiment thereof, as illustrated in the accompanying drawing.

### BRIEF DESCRIPTION OF THE DRAWINGS

FIG. 1 shows a store-and-forward server integrated into an IMS system, according to the present invention.

FIG. 2 shows session messaging using the store-and-forward server of the present invention in an IMS system.

FIG. 3 shows instant messaging carried out in an IMS system using the store-and-forward server of the present invention.

FIG. 4 shows signaling details of a messaging session according to the Session Initiation Protocol (SIP), according to the present invention, using a store-and-forward server.

FIG. 5 shows a SIP INVITE message such as that provided from the Call Processing Server (CPS) which is the logical name for the entity that contains the CSCF among other related elements such as the Home Subscriber Server (HSS) of FIG. 4 to the AS of FIG. 4.

FIG. 6 shows an INVITE message sent back from the application server (AS) of FIG. 4 to the CPS after receiving information from the MMSC.

FIG. 7 shows messaging via the application server, according to the present invention.

FIG. 8 shows messaging session via the MMS using the SIP method MESSAGE.

FIG. 9 shows messaging session via the MMS using the messaging transport protocol (IMTP).

FIG. 10 shows details of a MESSAGE with the content-disposition entity header utilized to signify the nature of the message, i.e., an instant message, according to the present invention.

### BEST MODE FOR CARRYING OUT THE INVENTION

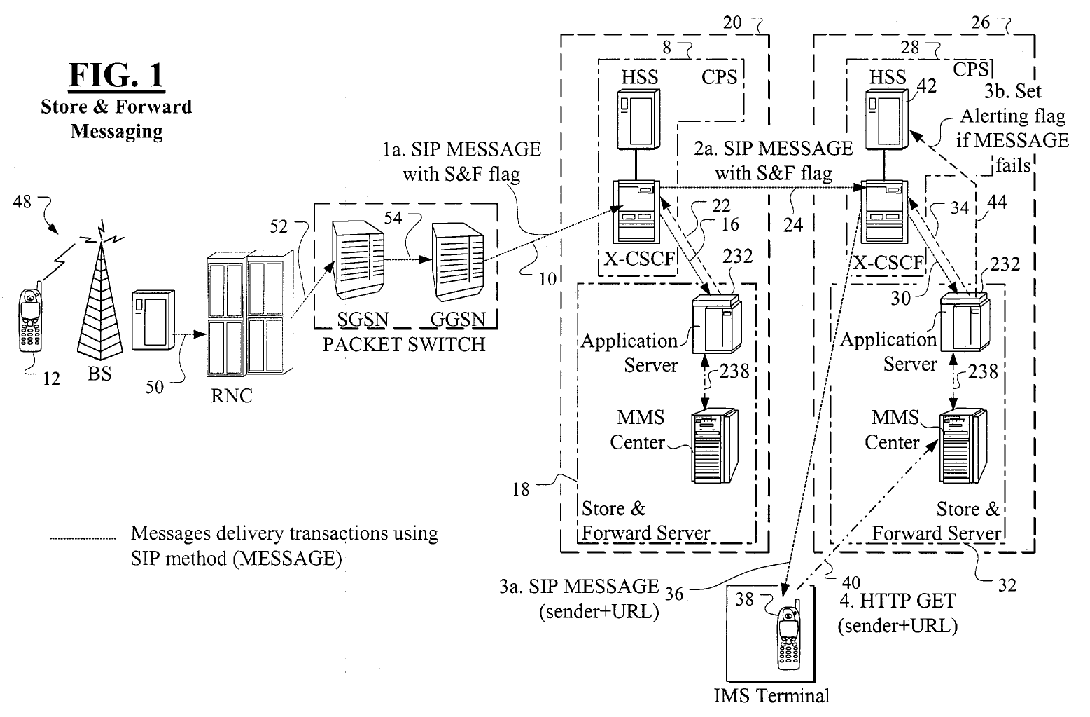

FIG. 1 shows a store-and-forward messaging approach applied to the IMS architecture and particularly to a CPS thereof, such CPS including at least a CSCF and perhaps also an HSS. A mobile originating SIP message is provided on a line 10 from user equipment (UE) 12 to a local CPS 8. As mentioned above, multimedia messaging being developed by the 3GPP includes the IETF's Session Initiation Protocol (SIP) disclosed in RFC 3261. It should be understood that the present invention is applicable to other SIP based networks using MMSC or MMSC-like functionality used for implementing messaging services. The SIP is an application-layer control (signaling) protocol for creating, modifying and terminating sessions with one or more participants. Such sessions include Internet multimedia conferences, Internet telephone calls and multimedia distribution. Members in a session can communicate via multicast or via a mesh of unicast relations, or in combination of these. SIP invitations used to create sessions (including messaging) carry session descriptions, which allow participants to agree on a set of compatible media types. SIP supports user mobility by proxying and redirecting requests to the user's current location. Users can register their current location. SIP is not tied to any particular conference control protocol. SIP is designed to be independent of the lower-layer transport protocol and can be extended with additional capabilities (quoted from the abstract of RFC 3261).

In instant messaging there is the possibility to simply forward a message from a sender to a receiver without keeping a copy in the network. On the other hand, there are variants of instant messaging, such as “chat” that require the network to store and maintain instant messages and messaging sessions that are established like another media session using SIP as the signaling protocol. The SIP message from the UE 12 to the CPS 8 on the line 10 includes, according to the present invention, a store-and-forward signaling flag which indicates to the network how to treat the message. In this way, the network can determine whether it should simply forward the message to the next entity on its way to the intended recipient or whether a session should be established for the exchange of instant messages between the UE 12 and the intended recipient or multiple recipients. In both cases, a store-and-forward mechanism would be appropriate and the new functionality can adapt existing MMSCs to fulfill this role in conjunction with the CPS 8, according to the present invention.

In case the SIP message on line 10 (MESSAGE method) includes the store-and-forward flag, the CPS 8 may forward the SIP message on the line 10 further on a line 16 to a store-and-forward server 18 (such as an MMSC adapted for this purpose with new functionality), which may be present in an originating network 20. The proposed server (enhanced MMSC) can interpret the SIP message to determine if the message needs to be sent to multiple recipients and can perform various group management functions by accessing other servers for obtaining addressing information (i.e. when the SIP message includes a URI that includes multiple recipients) as well as value-added services, as appropriate. After evaluating the SIP message provided by the CPS on the line 16, and storing the message at server 18, (if the flag so indicates) the server 18 then provides the SIP message (with the flag still indicating a store-and-forward mechanism is desired), on a line 22 back to the CPS 8. It should however be realized that the illustrated store-and-forward server 18 can be implemented within the CPS or within a CSCF residing therein or in another SIP server.

In any event, the CPS 8 then provides the SIP message on a line 24 to a terminating network 26 where a terminal of the intended recipient is accessible. If the terminal of the intended recipient is a new IMS or SIP client that only has an MM client and the SIP client for signaling but it does not have any other messaging application (SMS, WV, etc), the SIP MESSAGE could contain the content or a notification that could be used as a replacement for an SMS bearer. In that case the MM terminal will receive the notification in the SIP MESSAGE but will fetch the MM from the MMSC using a normal MM procedure as described below. The connection between the originating network 20 and the terminating network 26 need not be direct and multiple intermediate network nodes may be involved in the routing of the SIP message on the line 24 over various transport technologies. A CPS 28 within the terminating network 26 receives the SIP message with the store-and-forward flag set to indicate that the message should be stored and the CPS sends this message on a line 30 to a store-and-forward server 32 within the terminating network 26 that can be the MSMC server or an alternative entity. The appropriate storage function is carried out in this server 32 as indicated by the flag. The SIP message is then provided on a line 34 back to the CPS 28 where it is sent out on a line 36 to a terminating terminal such as an IMS terminal 38 as shown. The IMS terminal 38 can obtain messages through the store-and-forward server 32 such as by an HTTP GET request as part of the normal MM procedure after receiving the notification in the SIP MESSAGE or similar SIP method (NOTIFY) or as part of another messaging client that uses HTTP such as that shown on a line 40 between the IMS terminal 38 and the store-and-forward server 32. The store-and-forward server 32 may be according to the known proprietary MMSC adapted to use SIP.

Thus, according to the embodiment shown in FIG. 1, the SIP message on the line 10 is sent from the mobile originating terminal 12 to the SIP address of a mobile terminating (MT) terminal 38 using the IETF SIP messaging method. According to the present invention, based on the setting of a store-and-forward flag (or corresponding indicator) provided in the SIP message, the message can be optionally routed to a store-and-forward server 32 in the terminating network 26 or also to a store-and-forward server 18 in the originating network if the operator wants to provide some value-added services. In the terminating side 26, the message is always routed to the store-and-forward server 32. The terminating store-and-forward server 32 notifies the recipient using SIP messages 34, 36, where only the sender, subject, size and URL (possibly also other data) is sent. The actual message is not sent at this point. Based on the information provided on the line 36, the recipient will fetch the multimedia message from the store-and-forward server 32 using, e.g., HTTP, as indicated on the line 40. If the notification fails, an alerting flag is set in an HSS 42, as signaled by a signaling message on a line 44 from the server 32 to the HSS 42. HSS will alert the store-and-forward server when a subscriber is registered again. This means that the user is not reachable or out of coverage and the SIP message did not reached the terminal. Thus, the HSS will alert the store-and-forward server when the terminal is reachable for sending the notification to fetch the stored message. The MMSC can also utilize the specified interface with the Application Server (or similar SIP server) for subscribing (i.e. using SUBSCRIBE message) to the status of the user. Thus, other IMS entities (HSS or an alternative server) will take care of updating the user status and when the user becomes available the MMSC will receive a notification (i.e. NOTIFY) from the AS indicating that the user is available for receiving the notification signalling 34, 36. After the message has been fetched, a delivery report will be sent to the originating party, as in MMS, using either a SIP MESSAGE or SIP NOTIFY (if the send message to the store-and-forward server causes an implicit SIP subscription to the delivery report event).

The message notification part can also be implemented by mandating all the terminals to subscribe to the store-and-forward server. If that is done, the recipients would be notified when the message arrives. A drawback of such a solution, however, is that the store-and-forward server needs to maintain states for all users, even if only a fraction of them will receive messages.

Yet another method of implementation would be that the store-and-forward server would subscribe to an HSS or presence server or any other entity that would know when the recipient would be available. A drawback of this implementation mode is that such a mechanism requires that the actual interface between the MMSC and the Application Server should be used to communicate also with the Presence Server and furthermore, presence information would not be 100 percent reliable for this purpose.

The Application Server 232 of FIG. 1 could be a presence and/or location server or the S-CSCF or other SIP server could embody such functionality or have access to such information about user status or availability or appropriateness/desirability to receive a message notification. Communications between the MMSC and such an application server, S-CSCF or other SIP server can be done using SIP methods (SUBSCRIBE/NOTIFY) while the notification mechanism to the user can be done using the SIP method (MESSAGE or NOTIFY). Interactions can be set up with other directory or network entities such as the HSS of FIG. 1 for receiving information while user status or using HSS information to trigger messaging activity, when it becomes known that a user is registered or available for receiving a message notification.

FIG. 1 shows each of the store-and-forward servers 18, 32 implemented using the known MMSC in conjunction with an IMS Application Server 232. It also shows details of the packet switched part of a UMTS core network interfacing with a Radio Network Controller (RNC) and a base station (called “Node B” in 3GPP). The message delivery is shown starting on a radio link 48 from the MO terminal 12 to the base station (BS) and then on a line 50 to the RNC. From there it is provided by the RNC on a line 52 to an SGSN (Serving GPRS Support Node) which provides it on a line 54 to a GGSN (Gateway GPRS Support Node). From the GGSN it is provided on the line 10 to the CPS 8 and from there to the Store and Forward Server 18 as described previously, and so on.

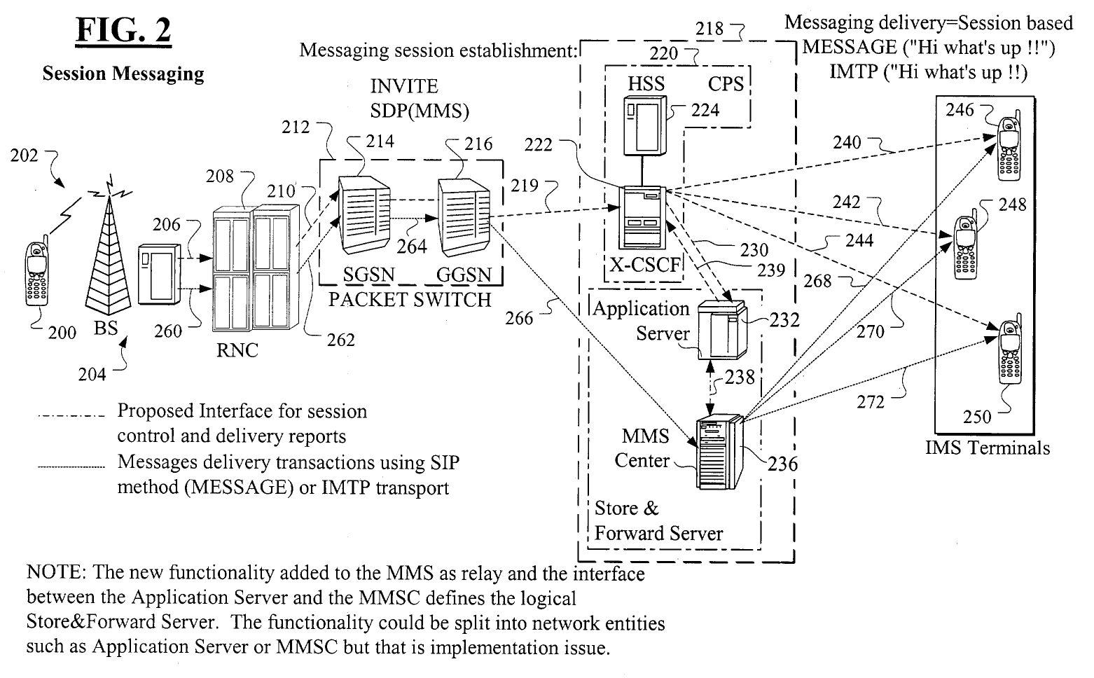

FIG. 2 is similar to FIG. 1 but shows a messaging session scenario. A Mobile Originating (MO) terminal 200 provides a wireless signal on a link 202 to a base station 204 which provides a SIP INVITE message on a line 206 to a radio network controller 208. The SIP invite may include in the message body a description according to the Session Description Protocol (SDP) about the media to be exchanged, such as RTP payload type, addresses and ports. In this case the SDP will indicate that the MO wants to establish a messaging session and the store and forward flag would be included as part of the session description. The SDP protocol is specified by the IETF in RFC 2327. The RNC 208 provides the SIP signaling on the line 210 to a core network (CN) 212 which may include an SGSN 214 and a GGSN 216, according to the UMTS specifications of the 3GPP. These are designed to handle Internet protocol (IP) packets and to route them to the appropriate destinations on the Internet. After such Internet routing, the message sent by the mobile originating terminal 200 will ultimately reach one or more local networks at the locale or locales of one or more destination mobile terminating terminals. Such a local network is shown in general as a network 218 for receiving the SIP signaling on a line 219. Within the network 218 is a CPS 220 similar to the CPS 28 of FIG. 1. Such a CPS 220 may include a CSCF 222 and an HSS 224 interconnected by a Cx interface to form the CPS 220. The CSCF 222 of the CPS 220 may provide the SIP signaling on a line 230 to an application server 232, such as shown in the 3GPP TS 23.218 v5.0.0 (2002-03) entitled, Technical Specification Group Core Network; IP Multimedia (IM) Session Handling; IP Multimedia (IM) Call Model; Stage 2 (Release 5).

According to the present invention, a store-and-forward device 236 such as the prior art MMSC is adapted and interfaced by means of an interface 238 for session control and delivery reports between the application server 232 and the store-and-forward device 236 and for user status subscription/notification to/from the Application Server acting as Presence server. The application server 232 may be used for analyzing the SIP signaling and checking the characteristics of the session to be established. It checks the SDP and finds the store and forward flag included as part of the session description indicating that the messages should be stored and forwarded. The application server modifies the content of the SDP to include the enhanced MMSC as the messaging server within the session. After the SDP is changed, the SIP signaling message is sent back on a line 239 to the CSCF to continue the session setup with the rest of terminals, as shown in a multicast session by means of signaling lines 240, 242, 244 to mobile terminating IMS terminals 246, 248, 250, respectively. After the messaging session setup, message delivery transactions will take place to the mobile terminating IMS or SIP based terminals 246, 248, 250 via the store-and-forward device 236 rather than the CSCF 222 or the application server 232 in order to allow the possibility of sending some of the messages in a converted format such as the format already known for use between an MMSC and a mobile terminal. Consequently, the actual messages, as opposed to the SIP signaling, are shown in FIG. 2 propagating from the mobile originating terminal 200 over the wireless link 202 from the base station 204 on a line 260 to the RNC 208 and from there on a line 262 through the packet switch of the core network 212 on a line 264, and from thence on a line 266 to the store-and-forward device 236, where they are relayed on respective links 268, 270, 272 to the mobile terminating terminals 246, 248, 250. These messages can be in the legacy format supported by the prior MMSC or in the RTP format (or the like) specified by the SDP in the SIP message body. The signaling on the lines 240, 242, 244 would only be provided in SIP signaling format to a given MT terminal in case it is able to use IP.

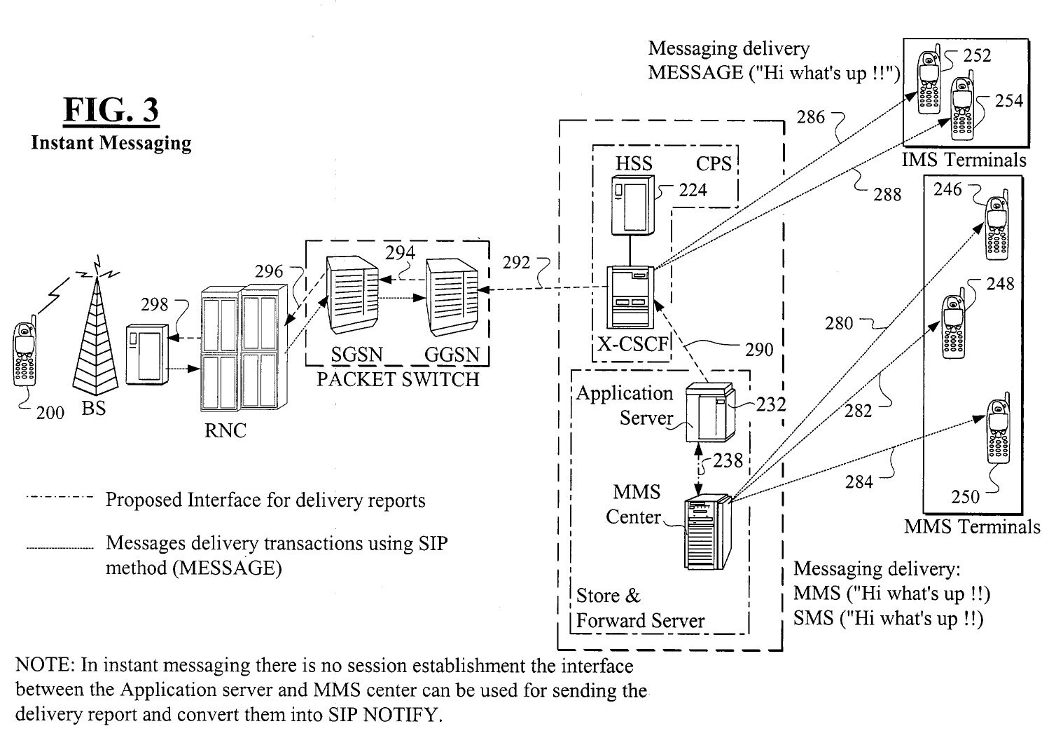

As shown in FIG. 3, it is not necessarily the case that a session is to be established because there may only be a need for forwarding the message to the intended recipient or recipients without any storage required. FIG. 3 describes with more detail the scenario depicted in FIG. 1, including IMS and legacy MMS terminals. In this case, as a part of the Store and forward mechanism a delivery report mechanism is included. Similarly to the SMS, the IMS messaging can define a delivery report mechanism that will be sent to the user using SIP method (MESSAGE, NOTIFY or others with similar functionality). The basis is the same as defined in FIG. 1 for the store and forward mechanism. Instead of a store-and-forward parameter there would be included a delivery report parameter. The rest of the procedure is similar to the one depicted in FIG. 1. In FIG. 3, there is no session establishment on the interface 238 between the application server 232 and the store-and-forward device 236 such as the MMSC. There is no SIP signaling between the AS 232 and the legacy MT (MMS) terminals 246, 248, 250 but only delivery of the message itself to the MT terminals from the MMSC 236 on links 280, 282, 284, respectively. The SIP messaging with the new (IMS or SIP based) MT terminals 252, 254 follow the procedure indicated in FIG. 1. The SIP message is forwarded on line 290 to the Application server 232 that checks the store and forward flag and sends the message to the MMSC server. The message is sent back on line 290 to the CSCF that will forward it on lines 286, 288 to the MT terminals 252, 254. When the MMSC receives the delivery report from MT terminals 246, 248, 250 on lines 280, 282, 284, the MMSC will so indicate to the AS 232 on line 238. The terminals 252 and 254 are IMS and they do not have a delivery report mechanism defined yet. This approach will facilitate the addition of such a Message delivery parameter in the parameters as well. Thus, when the terminals 252, 254 get the message and send a delivery report back to the CSCF, it will be forwarded to the AS 232 that will combine them and send the report to the Mobile Originating (MO) terminal 200. The AS 232 is shown providing SIP delivery notification (NOTIFY method but it is not limited to that and other SIP method such as MESSAGE with specific content type could used as well) signaling in the reverse direction, i.e., towards the MO terminal 200 on lines 292, 294, 296, 298 after being notified of delivery by the MMSC.

From the foregoing description and FIGS. 1-3 it should be evident that an MMS Center can be advantageously adapted to be integrated into IMS or SIP based systems. To do this, the invention shows that the functionality of the MMS center can be adapted to be able to perform the same messaging services as in IMS system while still being able to interface with mobile terminals according to the MMS methodology. The idea is to include a service relay that receives messages from IMS or similar SIP networks and maps them into equivalent MMS transactions. The relay should also handle all the IMS messages to perform the messaging services in IMS. This invention permits the same MMS centers to be upgraded and used in the IMS systems with IMS capable terminals and in the MMS system with legacy MMS Terminals. The MMS-IMS relay will require an interface between the application server or the Serving-CSCF and a message translator. The interface is used to receive the orders for establishing a messaging session, for exchanging delivery reports or message reception notifications. The Application Server or S-CSCF will send the addresses of the participants and their terminal capabilities. Afterwards, the MMS Center should be able to receive and send SIP methods (MESSAGE), IMTP messages (another transport protocol proposed for messaging in IETF that probably will be adopted in IMS) or messages from any similar transport protocol specifically for exchanging the messages content but not the signalling. Therefore, the MMS-IMS relay comprises two new features. Firstly, the interface between the MMS center (MMSC) and the Application server and/or the Serving-CSCF or other SIP servers. This interface is used for exchanging orders for establishing a messaging session among multiple users. The interface also is used for receiving control messages, user status information and delivery notifications from the MMS Center 236 to the application server. Thus, in case that the user sends single messages (using MESSAGE method) through the Application server or S-CSCF and it is delivered via the MMS Center, the MMS Center will send back the delivery report to the Application or S-CSCF and from there it will be forwarded as normal SIP NOTIFY method back to the originating mobile terminal 200. Therefore, this relay enables the use of the MMS center for messaging delivery using its default transport and then a conversion of the delivery reports back to SIP. The relay also permits sending of the MESSAGE or IMTP messages directly from the terminal to the MMS center. The MMS center then will forward the messages to the rest of participants, which information received via the new interface from the Application Server of the S-CSCF or from other server that provides information about the destination address (i.e. group server or directory server that stores the recipients URIs). The relay also permits sending of a SIP MESSAGE or other SIP method used for notification to the terminal about reception of a new message instead of using the SMS notification.

As will be appreciated from the foregoing, the actual specification in the prior art MMSC uses specific MMS messages for receiving and sending Multimedia messages between terminals. Therefore, to extend and ensure the lifetime of the MMSCs in the proposed IMS systems, according to the teachings hereof, an interface towards the application servers and/or the Serving-CSCF is required. Using that interface the MMS center will receive orders for establishing a messaging session between IMS terminals and will also use MMS for message delivery and notification to legacy MMS terminals. With this interface and the MMS relay the MMSC will be enhanced with additional functionality wherein SIP message can use a store-and-forward parameter to store the message and notify the terminal to fetch it. In IMS the session is established using SIP methods. The messaging session can be of the Instant messaging type where there is no session established and the messages are exchange used the SIP MESSAGE method, IMTP protocol or similar message transport protocol. In case the user wants to establish a messaging (chat) session the information is passed from the Application Servers or S-CSCF to the MMS Center. Therefore, this element will be included into the MMS Center to enable these capabilities into the existing MMS servers.

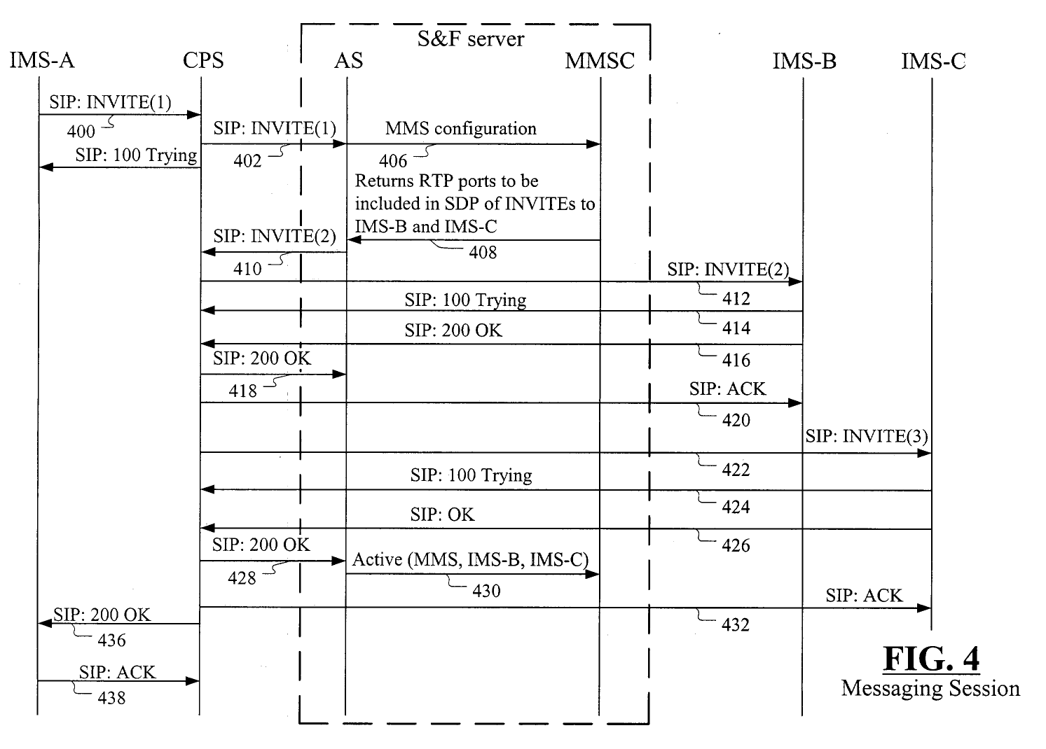

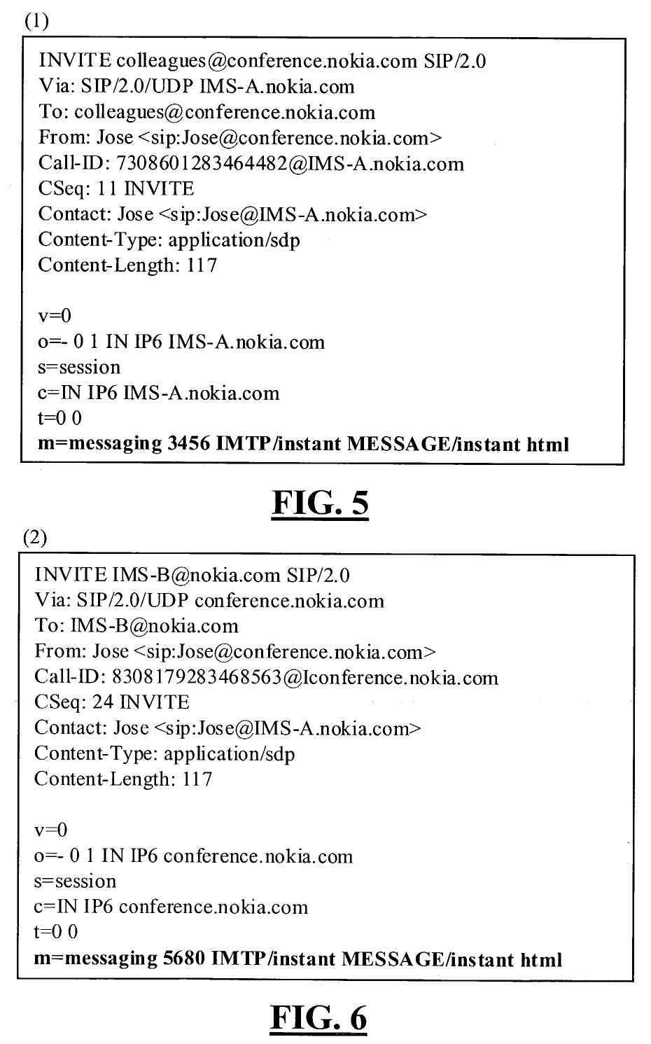

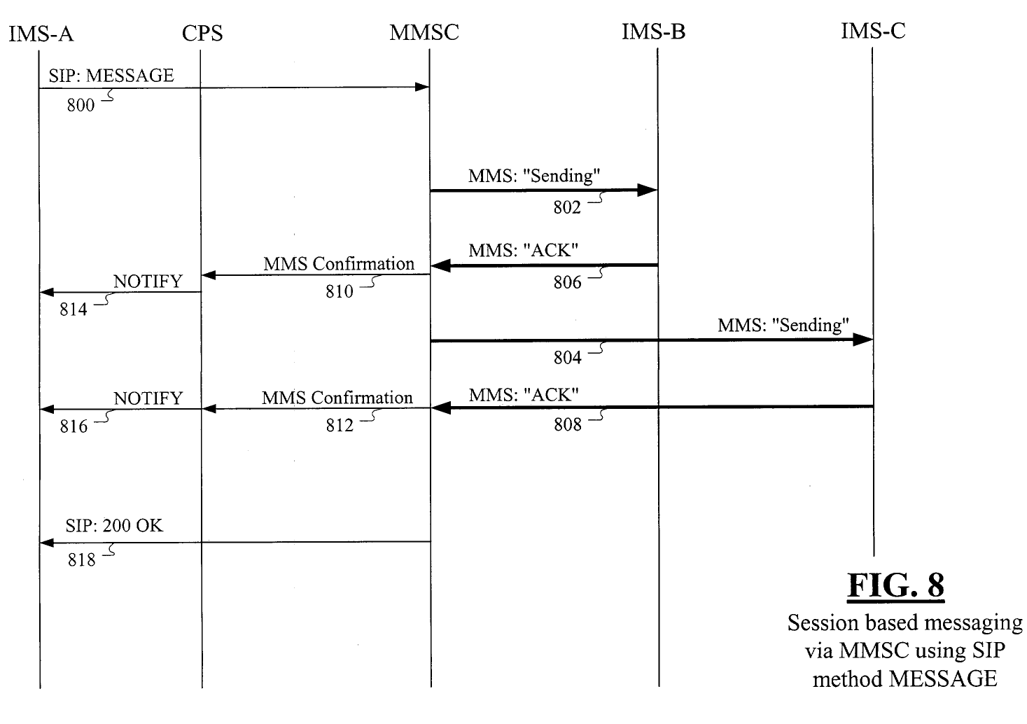

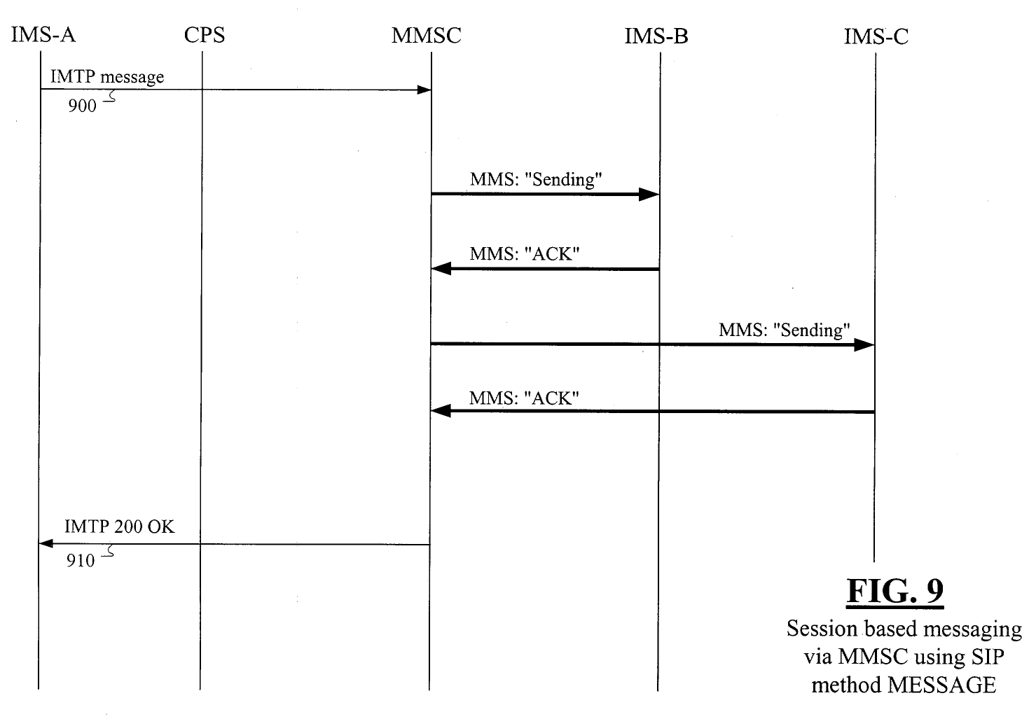

FIG. 4 shows a message exchange for a messaging session such as might be used in FIG. 2 except for only two IMS terminals (IMS-B, IMS-C) on the right hand side, as opposed to three (246, 248, 250) in FIG. 2. IMS-A is similar to the mobile phone 200 of FIG. 2 and provides a SIP INVITE message on a line 400 which may propagate over a network such as shown in FIG. 2 to a CPS such as the CPS 220 of FIG. 2. The CPS provides the SIP INVITE (see FIG. 5) on a line 402 to the store-and-forward server 404 of the present invention. This server 404 may include an application server (AS) such as the application server 232 of FIG. 2 in combination with an MMSC 236. Assuming a configuration such as the store-and-forward server of FIG. 2, the SIP INVITE signal on the line 402 is provided to the application server (AS) which in turn provides an MMS configuration signal on a line 406 to the MMSC. The MMSC in turn responds with a signal on a line 408 back to the application server indicative of RTP ports to be included in the SDP message body of the SIP INVITEs to be sent to the IMS-B and IMS-C by the CPS. Upon receipt of the signal on the line 408, the application server (AS) sends an INVITE on a line 410 augmented by the information provided by the MMSC (see FIG. 6) to the CPS such as the CPS 220 of FIG. 2. The CPS in turn sends a SIP INVITE message on a line 412 to IMS-B which may be similar to an IMS terminal 246 in FIG. 2. The IMS-B may respond with a status code 100, i.e., “trying” which is equivalent to a ringing signal. Upon answering, the IMS-B will send a SIP: 200 OK signal indicating success with the 200 status code, also to the CPS. The CPS will in turn inform the application server (AS) by means of a signal on a line 418 that the IMS-B has answered. The CPS will then acknowledge to the IMS-B that it has received its indication that it has answered the call as shown by an acknowledgement signal (ACK) on a line 420. At the same time as the previously described signaling to and from IMS-B or subsequently, the CPS may also send a SIP INVITE signal on a line 422 to IMS-C which may be similar to the MT terminal 248 of FIG. 2. Upon receiving the INVITE, the IMS-C will send back a “trying” signal on a line 424 and in this case answer the call and signal back the fact that it has answered on a line 426 in the form of a SIP status code 200 OK to the CPS. The CPS informs the application server (AS) of the fact that the IMS-C has answered by sending a signal on a line 428 to the AS. The AS then informs the MMSC that the IMS-B and IMS-C are now active, as shown by a signal on a line 430 from the AS to the MMSC. An acknowledgement is also sent to the IMS-C by the CPS as shown by a signal on a line 432. The CPS will then conclude the message exchange by sending the SIP status code 200 to the MO IMS-A as shown by a signal on a line 436. The IMS-A acknowledges with a signal on a line 438 to the CPS. Subsequently, the MMS can deliver message transactions using the SIP method (MESSAGE) or the selected messaging transport protocol (e.g. IMTP or other) as shown, e.g., in FIGS. 8 and 9.

The SIP invite signal on the line 402 of FIG. 4 is shown in detail in FIG. 5 with particular emphasis on the SDP portion thereof showing a flag at the end of the message body. It uses a “m” field with a value as shown “messaging 3456 IMTP/instant MESSAGE/instant html”. This value includes a number of separate pieces of information separated by spaces. The first value “messaging” indicates a messaging session. The “m” is used in SDP to indicate what media will be exchanged in the session (e.g. m=audio, m=video, m=message). Additionally, the SDP should include the port number and IP addresses used for exchanging the media between terminals through the messaging server (S&F server=MMSC). Thus, the incoming SDP indicated the IP address of IMS-A (e.g. “o” parameter in SDP indicates origin of the session. o=IMS-A.nokia.com) terminal and the port (e.g. 3456). When the SDP is analyzed by the S&F server (AS+enhanced MMSC) it is replaced the initial IMS-A address an port by the MMSC address (e.g. conference.nokia.com) and the port (5680). This is for setting the media (messaging) session between IMS-A, IMS-B and IMS-C terminals through the S&F server in the middle. The next piece of information “3456” will have to be defined and standardized at IETF. The format of “m” parameter is formed by: media type, port and transport (e.g. m=audio 49170 RTP/AVP 0) Therefore, “IMTP/instant” means that the IMTP message transport is being called on to be used in an instant messaging session. Similarly, “MESSAGE/instant” means MESSAGE is used as transport protocol for exchanging the media including the “instant” feature to the delivery. The next piece of information “html” indicates that the message is to be in the html format.

FIG. 6 shows the invite message sent back from the application server on the line 410 to the CPS after having received input on the line 408 from the MMSC. I.e., it includes the type of media that will be exchanged in the session (messaging) the port where the messaging server will receive the media (5680) and the transport protocol that will be used (IMTP/instant or MESSAGE/instant).

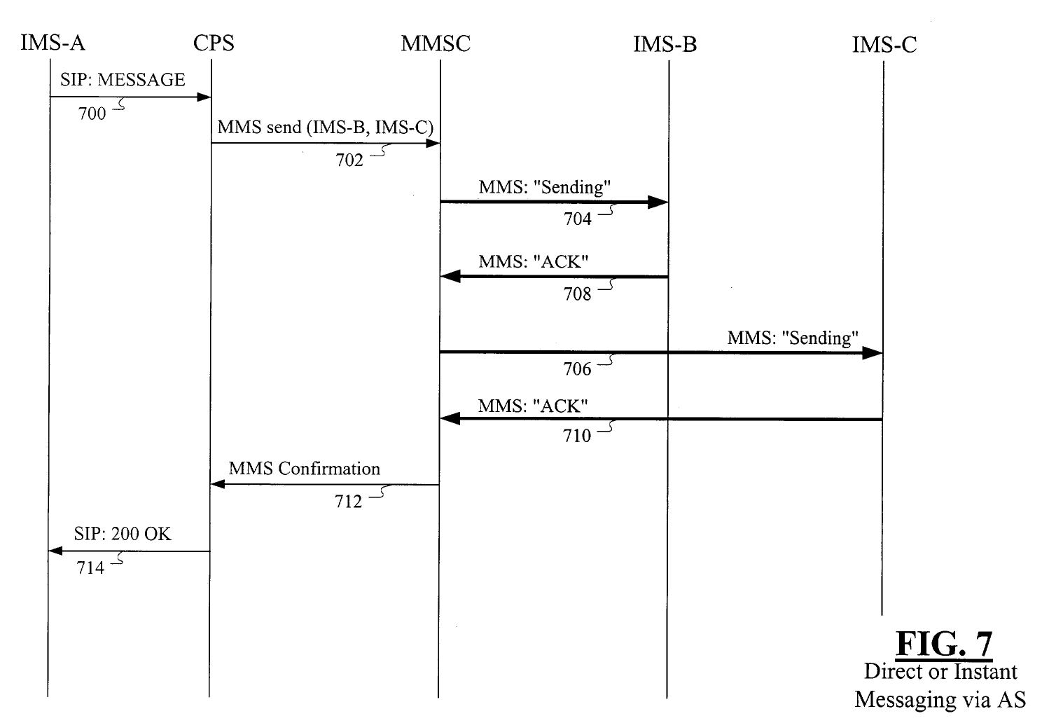

While FIG. 4 showed an example of how the store-and-forward server of the present invention fits into a signaling scenario for a messaging session, FIGS. 8-9 show messaging scenarios that would follow such a signaling scenario. On the other hand, FIG. 7 shows a instant messaging session according to FIG. 3 where the message is sent from the terminal to the CPS and from there to the MMSC that converts it into MMS to be sent to MMS terminals 246, 248, 250. In case the message is sent to one or both of the IMS terminals 252, 254 it does not need to be converted into MMS message and is sent on the lines 286, 288 as shown. It is to be noted that Instant messaging does not need the previous signaling of FIG. 4 for session establishment. The MO terminal just sends a MESSAGE to the remote MT terminals. Session messaging needs the signaling of FIG. 4 and then a transport protocol for the messages that can be IMTP or MESSAGE as well over TCP or any congestion safe protocol defined at the IETF for messaging. Thus, MESSAGE can be used for instant messaging and also as transport like IMPT.

For instance, FIG. 7 shows messaging via the application server wherein both the CPS and the IMS-B and IMS-C communicate a message using the legacy MMS message with the CPS acting as an intermediary between the SIP and the MMSC, i.e., serving as a translator. The proposed functionality of converting SIP message into MMS message can either reside in the CPS (at the AS) or at the MMSC depending on product implementation. The IMS-A, on the other hand, provides a SIP message on a line 700 to the CPS. The CPS does a translation and in turn provides an MMS send signal on a line 702 to the MMSC indicating that the message should be sent to both IMS-B and IMS-C. The MMSC does this with an MMS “sending” message on a line 704 and on a line 706 to the IMS-B and IMS-C, respectively. The IMS-B sends back an acknowledge signal on a line 708 according to the MMS protocol used for exchanging MMS messages and the IMS-C likewise sends an acknowledge on a line. 710 back to the MMS. The MMSC sends a confirmation signal on a line 712 back to the CPS which in turn does a translation and sends a SIP status code 200 indicating success on a line 714 back to the IMS-A.

It should be realized that the translation of FIG. 7 can be handled at the CPS or at the MMSC. If done at the MMSC it would affect the flow of signalling shown between the CPS and the MMSC. The conversion is shown in the figure as being done at the CPS but if the conversion is done at the MMSC then the MESSAGE and 200 OK signals should go also between CPS and MMSC and there need be no MMS send or confirmation.

FIG. 8 shows another scenario but this time with session messaging via the MMSC using the SIP method MESSAGE as transport protocol. FIG. 9 shows another scenario of session messaging via MMSC using IMTP as transport protocol. In these two scenarios the session has been established indicating in the SDP that the MMSC will be used as intermediate messaging server and either the IMTP or MESSAGE method will be used as transport. The SIP MESSAGE is provided on a line 800 from the IMS-A to the MMSC. In this case, the MMSC is able to interpret the SIP method MESSAGE and, in response, provides the message according to the MMS protocol “sending” on a line 802 to the IMS-B and likewise on a line 804 to the IMS-C. Each of the MT terminals respond with an acknowledge signal according to the MMS protocol on lines 806, 808, respectively. In response to the acknowledge signals, the MMSC sends separate confirmation signals on lines 810, 812, respectively to the CPS indicating acknowledgement by IMS-B and IMS-C. The CPS (or the MMSC enhanced with the proposed functionality) converts this signal into the corresponding SIP NOTIFY (or SIP MESSAGE) method on lines 814, 816 back to the MO IMS-A. The MMSC then sends a SIP “200” status code back to the IMS-A as shown by a signal on a line 818.

FIG. 9 is similar to FIG. 8 except using an IMTP (Instant Messaging Transport Protocol) message directly from the mobile originating terminal IMS-A to the MMSC as shown by a signal on a line 900. The signaling sequence between the MMSC and the mobile terminating terminals are IMS-B and IMS-C are the same as shown in FIG. 8 after receipt of the SIP message on the line 800. However, the MMSC confirmation messages of FIG. 8 are not sent back to the CPS, as in FIG. 8, but rather an IMTP status code 200 is provided back to the IMS-A as shown by a signal on a line 910.

For a case of instant messaging (without session establishment) the MESSAGE method is also used for sending the message. In this case since no session is established, it cannot be indicated by the SDP the “instant” nature of the session and the MMSC can be included in the path of the messaging exchange.

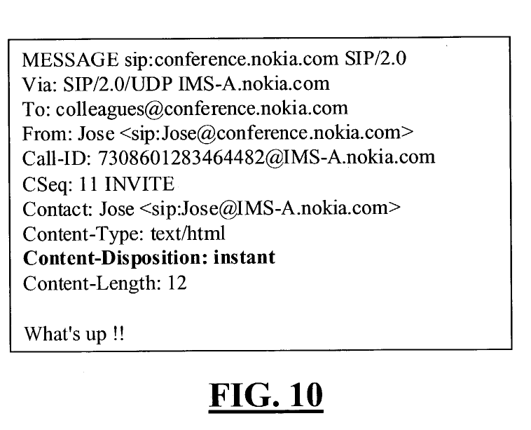

Therefore, FIG. 10 shows how the Content-Disposition entity header (but not limited to this header) can be utilized, according to the present invention, to indicate in the MESSAGE itself the “instant” nature of the message. The other alternative would, e.g., be “store&fwd” according to the present invention, to signify that a store-and-forward message is desired.

Basically we can have instant messages and session based messages. The former uses MESSAGE as such for sending the messages from originating terminal to terminating terminals. How to handle the message should be included somewhere in the headers of the SIP message (MESSAGE). If we want to use the store and forward feature or provide a delivery report concerning the message then such has to be indicated somewhere, preferably in a SIP header within the MESSAGE method (i.e. Content-Disposition or similar). The proposed possibility is to include that characteristic in the header “Content-Disposition” within the MESSAGE (e.g. Content-Disposition=S&F or Content-Disposition=instant). Then the CPS, or more specifically the AS, checks the header and determines that the MMSC has to be involved to store the message or to send the message to other MMS terminals.

On the other hand, session based messaging requires a session establishment before starting the messages exchange. For the session set up the SIP message (INVITE) is used. SDP is used for indicating the transport protocols used for the media exchanges. Again, if the terminal wants to have the Store and Forward or the delivery report feature or some of the terminals are not IMS (SIP) capable but rather MMS-capable, then MMSC should be included as an intermediate server for the message exchange. Both the “instant” and the “S&F” feature should be includable in the SDP as part of the session description. Then the CPS (more likely the AS) checks the content of the SDP and determines that it has to change the SDP to include the MMSC later in the path during the media exchange. The AS modifies the SDP and sends it back to the CPS and continues the normal session setup using INVITE. Once the session is established, the media exchange (messages) starts and either IMTP or MESSAGE over TCP or other congestion sage protocol for messaging can be used for exchanging messages between the terminals where the MMSC is intermediate element because it was previously included during the session set-up by the AS. Thus all the messages go through the MMSC that performs the S&F or message delivery feature that the terminal indicated in the first INVITE.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. Method, comprising the steps of:
receiving a message including a signaling flag indicative of whether to establish an instant messaging session for instant messages from and to a client user equipment (UE) or to simply forward a message from said UE, and
storing and forwarding an instant message from said UE after establishing said instant messaging session, or simply forwarding said message including said signaling flag from said UE depending on said signaling flag.

2. The method of claim 1, wherein said message includes a message body having a field and value together indicative of characteristics of said instant messages or said instant messaging session.

3. The method of claim 2, wherein said message is a SIP INVITE and said field is indicated in a session description protocol (SDP) by a single letter m followed by an equal sign followed by said value.

4. The method of claim 1, wherein said message is a SIP message including a content-disposition entity or similar header indicative of whether to store and forward said SIP message or to simply forward said SIP message without storage or using SIP message reception and delivery notification.

5. The method of claim 4, wherein said SIP message is a SIP MESSAGE or a SIP method with the same functionality (SIP NOTIFY).

6. The method of claim 5, wherein said content-disposition or similar header has a format: Content-Disposition: instant or Content-Disposition: store&fwd.

7. The method of claim 4, wherein said content-disposition header or similar has a format: Content-Disposition: instant or Content-Disposition: store&fwd.

8. The method of claim 1, further comprising the step of:
determining availability of said UE for receiving said instant messages or for establishing said instant messaging session and carrying out said step of storing and forwarding or simply forwarding said message depending on said availability.

9. The method of claim 8, further comprising the step of:
sending a notification to said UE concerning a stored message after availability of said UE is determined.

10. The method of claim 9, wherein said sending a notification is carried out using a SIP method.

11. The method of claim 10, wherein said SIP method comprises a SIP MESSAGE or SUBSCRIBE/NOTIFY.

12. The method of claim 2, wherein said message is a SIP method and said field is indicated in a session description protocol (SDP).

13. The method of claim 12, wherein extensions to said SDP comprise media descriptors for indicating different types of messaging.

14. The method of claim 13, wherein said different types include instant messaging and session based messaging.

15. The method of claim 13, wherein said SDP is modifiable.

16. The method of claim 1, wherein said message is a SIP message having extensions for implementing instant messaging and store and forward messaging.

17. The method of claim 9, wherein said notification is carried out by an extension to a SIP method (MESSAGE).

18. Apparatus, comprising:
means for receiving a message including a signaling flag indicative of whether to establish an instant messaging session for instant messages from and to a client user equipment (UE) or to simply forward a message from said UE, and
means for storing and forwarding an instant message from said UE after establishing said instant messaging session, or simply forwarding said message including said signaling flag from said UE depending on said signaling flag.

19. The apparatus of claim 8, wherein said message includes a message body having a field and value together indicative of characteristics of said instant messages or said instant messaging session.

20. The apparatus of claim 9, wherein said message is a SIP INVITE and said field is indicated in a session description protocol (SDP) by a single letter m followed by an equal sign followed by said value.

21. The apparatus of claim 8, wherein said message is a SIP message including a content-disposition entity or similar header indicative of whether to store and forward said SIP message or to simply forward said SIP message without storage or using SIP message reception and delivery notification.

22. The apparatus of claim 11, wherein said SIP message is a SIP MESSAGE or a SIP method with the same functionality.

23. The apparatus of claim 12, wherein said content-disposition header has a format: Content-Disposition: instant or Content-Disposition: store&fwd.

24. The method of claim 11, wherein said content-disposition header has a format: Content-Disposition: instant or Content-Disposition: store&fwd.

25. The apparatus of claim 18, further comprising means for determining availability of said UE for receiving said instant messages or for establishing said instant messaging session wherein said means for storing and forwarding said instant message or simply forwarding said message does so depending on said availability.

26. The apparatus of claim 25, wherein a notification is sent to said UE concerning a stored message after availability of said UE is determined.

27. The apparatus of claim 26, wherein said notification is carried out using a SIP method.

28. The apparatus of claim 27, wherein said SIP method comprises a SIP MESSAGE or SUBSCRIBE/NOTIFY.

29. The apparatus of claim 19, wherein said message is a SIP method and said field is indicated in a session description protocol (SDP).

30. The apparatus of claim 29, wherein extensions to said SDP comprise media descriptors for indicating different types of messaging.

31. The apparatus of claim 30, wherein said different types include instant messaging and session based messaging.

32. The apparatus of claim 30, wherein said SDP is modifiable.

33. The apparatus of claim 18, wherein said message is a SIP message having extensions for implementing instant messaging and store and forward messaging.

34. The apparatus of claim 26, wherein said notification is carried out by an extension to a SIP method (MESSAGE).
